(19) United States
(12) Patent Application Publication
(10) Pub. No.: US 2009/0047624 A1
(43) Pub. Date: Feb. 19, 2009

(54) Ultrasonic scaler

(76) Inventor: Chih-I Tsai, Xinzhuang City (TW)

Correspondence Address: Bruce H. Troxell;Troxell Law Office Pllc, Suite 1404, 5205 Leesburg Pike, Falls Church, VA, 22041, US

(21) Appl. No.: 11/889,465

(22) Filed: Aug. 13, 2007

(51) Int. Cl. A61C 17/20; G06F 17/00

(52) U.S. Cl. 433/119; 235/375

(57) ABSTRACT

A RFID (Radio Frequency Identification) reader is installed in the main unit of an ultrasonic scaler, which synchronizes with the antenna installed in the handpiece. Inside of The TIP (Insert or Piezo hand piece) consists of a tag, which uses RFID technology to read, write, and identify the information of the insert or tip. This provides the medical clinicians useful operation assistance, the necessary evidence on when to change to a new insert or tip, and to prevent improper usage of the insert or tip.

### BACKGROUND OF THE INVENTION

(a) Field of the Invention

The invention accommodates different kinds of the TIP in ultrasonic scaler. It uses RFID technology to read, write, and identify the information of the TIP in ultrasonic scaler.

(b) Description of the Prior Art

Periodontosis is a common tooth disease which damages the connective tissues and eventually leads to tooth loss. The main cause of the disease is plaque and calculus. In order to prevent this disease, regular dental cleaning is recommended by most dentists. Most dentists use ultrasonic scaler or dental scaler to remove tooth fungus and calculus found in between the gum line.

Calculus forms due to high density of saliva and can be found in the salivary gland opening on the surface of tooth. Because of calcification, it becomes harden gradually, thus it becomes difficult to remove.

Ultrasonic scaler is the most common dental cleaning tool used today. It uses ultrasonic waves to tremble the surface on the tooth to achieve the cleaning result. However, the length of the insert or tip on the scaler deteriorates and becomes shorten after repeated uses. Hence it is crucial for medical clinicians to check the length of the insert or tip before operating on the patient. It is recommended to replace a new insert or tip when the operating time reaches less than 50%. There is no standard on when to change to a new insert or tip hence the possibility of wasting insert or tips exists. By establishing a clear standard enables medical clinicians to resolve this issue.

### SUMMARY OF THE INVENTION

The invention offers a more advanced ultrasonic scaler which using wireless identification application to provide medical clinicians useful operation assistance, the necessary evidence to change to a new insert or tip, and to prevent improper usage of the insert or tip.

The inventions include: one main unit, one handpiece, and one insert or tip. The main unit consists of one control unit, one power unit, one RFID reader, one display, and numerous control knobs. The handpiece has antenna when connecting with main unit, it forms an electric connectivity with RFID reader. The insert or tip also has a built-in identification RFID tag which stores information on identification code, manufacturing date, accumulates the number of usage and duration or time of use, identify types of insert or tips, and so on. Thus, when medical clinician connects the insert or tip with the handpiece, the RFID reader is able to read or write the information stored on the handpiece through the antenna and transfer the data to the display. This provides the evidence and proper guidance to medical clinician on when to change to a new insert or tip. When the insert or tip is not connected to the main unit, the main unit remains locked and becomes idle. The data stored in the insert or tip is rewritable.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 is an overview of the present invention;

FIG. 2 is an explosion diagram of the present invention;

FIG. 3 is a cutaway view of the present invention; and

FIG. 4 is a block diagram of the present invention.

### DETAILED DESCRIPTION OF THE PREFERRED EMBODIMENTS

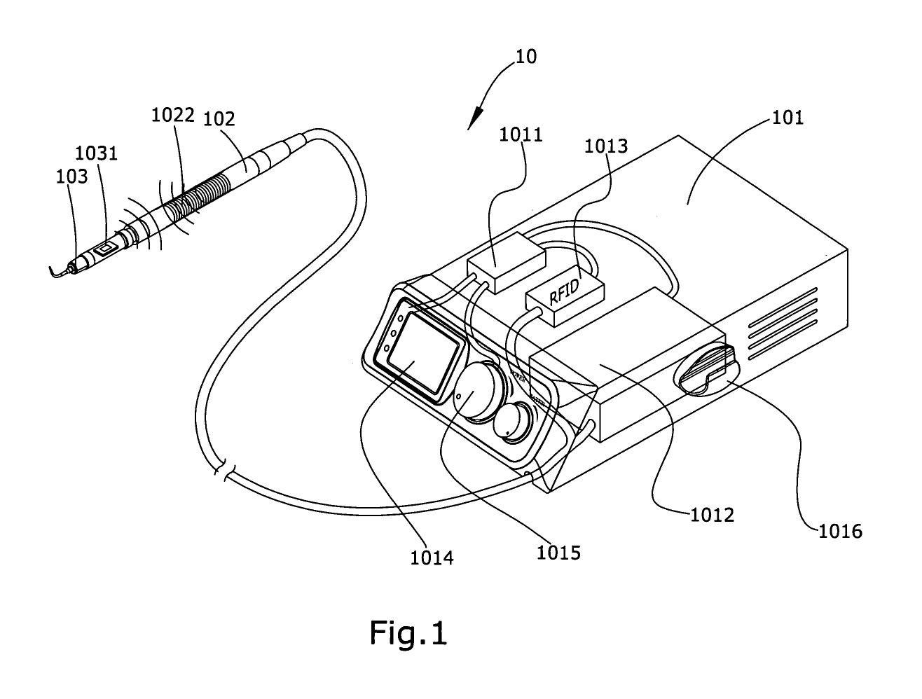

Please refer to FIG. 1 for complete overview of the invention. There are two common types of ultrasonic scaler 10 today: Magnetostrictive ultrasonic scaler and Piezoelectric ultrasonic scaler.

The major difference is the handpiece 102. When using Piezoelectric ultrasonic scaler, insert or tip 103 must be connected with handpiece 102 therefore becomes one unit, then it is connected with main unit 101 to complete the setup. As for Magnetostrictive ultrasonic scaler, main unit 101 and handpiece 102 is already connected as one unit. Insert or tip 103 is then connected to handpiece 102 to complete the setup.

Through RFID technology, the antenna 1022 which is inside of handpiece 102 connects wirelessly with the RFID reader 1013 which is inside of main unit 101 reads or writes the data stored in insert or tip 103. These data is then calculated by control unit 1011 and transmits to display 1014 of the main unit 101. These data includes: identification code, manufacturing date, accumulation of usage, duration or time of usage, types of insert or tip used, and so on. The information provides operational guidance to medical clinicians.

There are many different kinds of insert or tip 103 in the market today. Some shapes are identical but serve entirely different functions. The invention consist a function that enables medical clinician to quickly identify the function and type of insert or tip used 103. This function does not change the normal operation procedure of the ultrasonic scaler 10.

Control knob 1015 of the main unit 101 is used to adjust the power level of the generator 1012. It does not affect the normal practice by any medical clinician. The data of manufacturing date, accumulation and frequency of use, and so on provides guidance and evidence to medical clinician on when to change to a new insert or tip 103. Thus, it enables the insert or tip 103 to operate at optimal level at all time.

RFID reader 1013 writes or records data into RFID tag 1031 after every use to accumulate number of use as well as time of use. The handpiece 102 does not activate and receive any data without installing the insert or tip 103. This enables the main unit 101 to remain in idle mode and it also prevents the improper usage of insert or tip 103. And handpiece 102 is set on the clip 1016.

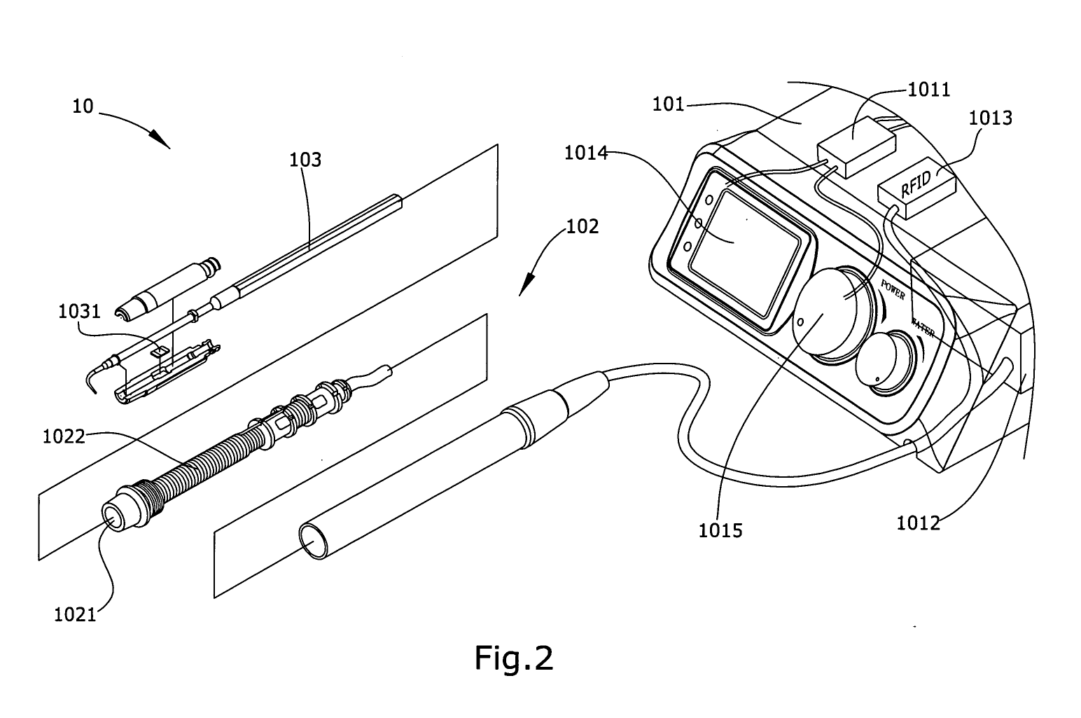

Please refer to FIG. 2, the invention consists of one main unit 101 with one control unit 1011, one generator 1012, one RFID reader 1013. Control unit 1011, generator 1012, RFID reader 1013 are installed inside of main unit 101. Display 1014 and numerous control knobs 1015 are installed on the surface of main unit 101.

There is electric connectivity between the following item: control unit 1011, generator 1012, RFID reader 1013, display 1014, and control knobs 1015.

Please refer to FIGS. 1 and 2, Said Clip 1016 is installed on the surface of main unit 101 to hold the handpiece 102. One end of the handpiece 102 connects with main unit 10. The other end is a connecting hole 1021 with antenna 1022 installed inside and it connects with RFID reader 1013 of the main unit 101.

The data in the RFID reader 1013 is transmitted through antenna 1022. The handpiece 102 has a connecting hole 1021 on one end which connects to insert or tip 103. Inside of the insert or tip 103 has a RFID tag 1031 which stores data includes: identification number, manufacturing date, accumulation of use, time of use and so on.

When connecting insert or tip 103 and the handpiece 102, the RFID reader 1013 reads the data stored in the RFID tag 1031 and transmits to the control unit 1011 of the main unit 101 for calculation. After the calculation, the data is then shown on the display 1014 to provide the guidance and evidence to medical clinician on when to replace a new insert or tip 103. It also prevents the improper usage of insert or tip 103 on the main unit 101.

The design of the invention is non-contact. It uses RFID technology to read or write the data inside of RFID tag 1031. Hence, the main unit 101 is able to obtain the data inside of the RFID tag 1031 without any contact.

Insert or tip 103 must be cleaned and sanitized after use, hence the RFID tag 1031 is built inside of insert or tip 103 to provide water-proof protection. To obtain the data, medical clinician simply plug the insert or tip 103 into the connecting hole 1021 of the handpiece 103. The data shall automatically transfer from insert or tip 103 to display 1014.

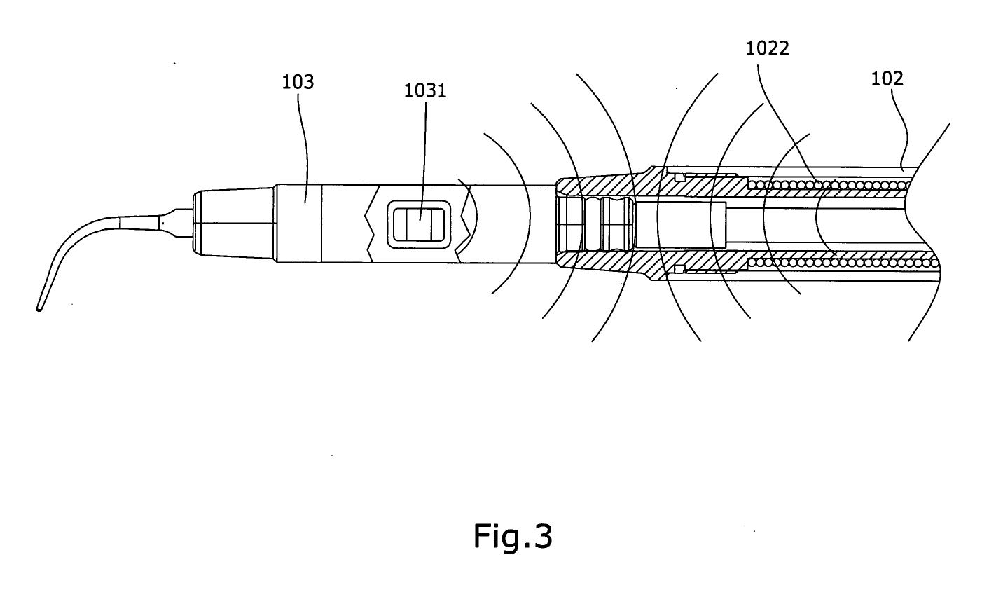

Please refer to FIG. 3 is a cut way view of the invention. As mentioned previously, the RFID reader 1013 connects with RFID tag 1031 using RFID technology through the antenna 1022 of the handpiece 102 to transmit the data. The data is transmitted wirelessly without any contact. The data in the insert or tip 103 includes identification number, manufacturing date, accumulation of use, duration and time of use, type of insert or tip used 103, and so on.

The insert or tip 103 must be cleaned and sanitized after use. Hence, the built-in RFID tag 1031 is extremely crucial design to ensure the water-proof function.

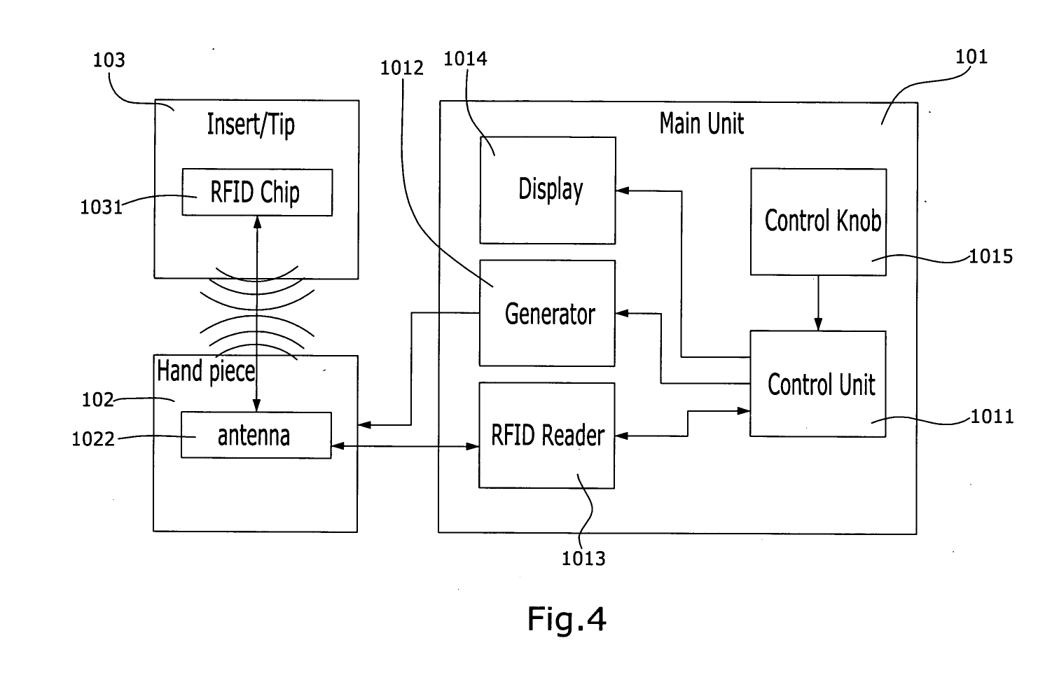

Please refer to FIG. 4 for the diagram of the invention. Again as mentioned previously, before starting the ultrasonic scaler 10, insert or tip 103 must plug into the connecting hole 1021 of the handpiece 102 hence insert or tip 103 and handpiece 102 becomes one unit. RFID reader 1013 reads or writes the data on the RFID tag 1031 of the insert or tip 103 through the antenna 1022 of the Handpiece 102. The data is then transmitted to control unit 1011 for calculation and shows the calculated data on the display 1014. The data includes: identification code, manufacturing date, accumulation of use, duration or time of use, and etc.

Furthermore, when insert or tip 103 connects with handpiece 102, the generator 1012 produces vibration power which transmits it to insert or tip 103 through handpiece 102. This power drives the insert or tip 103 which generates ultrasonic vibration. Control knob 1015 is used for power adjustment and through the display 1014, medical clinician can easily monitor the status of insert or tip 103.

In summary, when insert or tip 103 connects with handpiece 102, the main unit 101 automatically reads or writes the data inside the insert or tip 103. The data is defined as: identification code, manufacturing date, accumulation of use, accumulation of duration or time use, different types of insert or tip used, and so on. The invention integrates RFID technology to ultrasonic scaler which enables the scaler to read and write the relevant data. Hence the invention provides the necessary evidence and guidance to medical clinician on when to replace a new insert or tip and to prevent any improper usage.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. An ultrasonic scaler which medical clinicians use for dental cleaning includes the following:
one main unit, one control unit, one generator, one RFID (Radio Frequency Identification) reader, one display, and numerous control knobs; electrical connectivity between the following items: control unit, generator, RFID reader, display and control knob;
one handpiece installed with antenna which is used for transmitting data; inside of the handpiece consists of antenna which connects with RFID reader wirelessly;
one insert or tip, which installed at one end of handpiece, consists of a RFID tag; when integrating with handpiece, the RFID reader reads or writes the data inside of the tag and then transmits the data to display of main unit.

2. The combination defined in claim 1, the main unit is piezo ultrasonic with handpiece.

3. The combination defined in claim 1, the main unit is ultrasonic scaler which uses ultrasonic insert.

4. The combination defined in claim 1, the main unit consists of a clip on the side which is used for holding the handpiece.

5. The combination defined in claim 1, the ultrasonic handpiece has an installation hole.

6. The combination defined in claim 1, wherein the wireless identification device uses RFID technology to read the data storage in the RFID tag.

7. The combination defined in claim 1, wherein the tagset of the ultrasonic scaler consist of the following data-storage functions:
identification, manufacturing date, accumulates the usage number, duration or time of use, types of insert or tips used.
